(19) United States
(12) Patent Application Publication
(10) Pub. No.: US 2026/0289812 A1
(43) Pub. Date: Sep. 24, 2026

(54) PROCESSING APPARATUS, PROCESSING METHOD, AND NON-TRANSITORY COMPUTER-READABLE MEDIUM

(71) Applicant: NEC Corporation, Tokyo (JP)

(72) Inventors: Noboru YOSHIDA, Tokyo (JP); Hiroaki TAKEUCHI, Tokyo (JP); Naoki SHINDOU, Tokyo (JP); Yuta NAMIKI, Tokyo (JP); Youhei SASAKI, Tokyo (JP); Jianquan LIU, Tokyo (JP)

(73) Assignee: NEC Corporation, Tokyo (JP)

(21) Appl. No.: 19/471,779

(22) PCT Filed: Apr. 10, 2024
(86) PCT No.: PCT/JP2024/014494

§ 371 Date: Oct. 2, 2025

(30) Foreign Application Priority Data
Apr. 12, 2023 (JP) 2023-064775

(51) Int. Cl. G06T 7/73; G06T 7/60; G06V 40/10; G06V 40/20

(52) U.S. Cl. CPC G06T 7/73; G06T 7/60; G06V 40/10; G06V 40/23; G06T 2207/30196; G06V 2201/07

(57) ABSTRACT

This processing device, if a human body of a prescribed height is captured in a prescribed direction in an image: determines whether the human body is facing forward, backwards, left or right, and determines the degree to which the human body is facing sideways, on the basis of a reference value (theoretical value) indicating an in-image lateral distance between a first key point and a second key point of the human body, the in-image lateral distance (actual measurement value) between the first key point and the second key point, and the positional relationship between a key point on the right side of the human body and a key point on the left side of the human body on the image; and determines the direction of the human body in the image on the basis of the determination results.

### TECHNICAL FIELD

The present invention relates to a processing device, a processing method, and a program.

### BACKGROUND ART

Techniques related to the present invention are disclosed in PTL 1 to PTL 4.

The technique disclosed in PTL 1 derives, based on posture information, a movement line of a customer in a store, including an orientation of a body of the customer. The posture information includes information of an orientation of a face of the customer. The orientation of the face of the customer is identified based on a mutual positional relationship between parts of the customer by using image processing and extracting, for example, a contour, a range of hair, and a range of the face of the customer.

The technique disclosed in PTL 2 generates posture estimation data indicating positions of articulation points of a person. Next, the technique calculates, based on the posture estimation data, a length of a predetermined part (upper arm, for example) of a human body, and multiplies the length of the predetermined part by a predetermined value to calculate a length of a torso of the human body. The technique calculates, based on the posture estimation data, a length of a shoulder width of the human body. The technique determines that the human body is in a lateral orientation based on a ratio between the length of the torso and the length of the shoulder width of the human body. Specifically, in a case where the shoulder width is shorter than ⅓ of the length of the torso, the body is determined to be in a lateral orientation.

The technique disclosed in PTL 3 estimates a height of a person based on a two-dimensional skeleton structure indicating positions of a plurality of key points on the person.

The technique disclosed in PTL 4 searches, based on a two-dimensional skeleton structure indicating positions of a plurality of key points on a person, for an image including a human body with a similar posture or a human body with a similar motion.

### CITATION LIST

PTL 1: JP 2019-139321 A

PTL 2: JP 2022-091612 A

PTL 3: JP 7173341 B2

PTL 4: WO 2021/084677 A1

### SUMMARY OF INVENTION

### Technical Problem

PTL 2 discloses a technique for determining an orientation of a human body based on data indicating positions of a plurality of key points on a person. Specifically, the technique disclosed in PTL 2 determines that the human body is in a lateral orientation based on the data indicating the positions of the plurality of key points on the person. What the technique disclosed in PTL 2 is able to determine is whether a human body is in a lateral orientation. If it is possible to more finely determine an orientation of a human body, a technique for determining an orientation of a human body based on data indicating positions of a plurality of key points on a person expands in versatility. None of PTL 1 to PTL 4 describes the issues and their solutions.

In view of the issues described above, an object of the present invention is to provide a processing device, a processing method, and a program for more finely determining an orientation of a human body in a technique for determining an orientation of a human body based on data indicating positions of a plurality of key points on a person.

### Solution to Problem

According to an example aspect of the present invention, it is provided a processing device including:
a skeleton structure detection means for detecting a plurality of key points on a human body included in an image;
a reference information generation means for generating, based on the plurality of key points, reference information indicating a height of the human body or a length of a predetermined part of the human body;
a reference value calculation means for calculating, based on the reference information, a reference value indicating a distance between a first key point and a second key point on the human body in lateral directions on the image in a case where the human body has appeared in the image in a predetermined orientation;
an actual measurement value calculation means for calculating, based on the plurality of key points, an actual measurement value indicating a distance between the first key point and the second key point on the human body in the lateral directions on the image; and
an orientation determination means for determining, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

According to an example aspect of the present invention, it is provided a processing method including causing one or more computers to:
detect a plurality of key points on a human body included in an image;
generate, based on the plurality of key points, reference information indicating a height of the human body or a length of a predetermined part of the human body;
calculate, based on the reference information, a reference value indicating a distance between a first key point and a second key point on the human body in lateral directions on the image in a case where the human body has appeared in the image in a predetermined orientation;
calculate, based on the plurality of key points, an actual measurement value indicating a distance between the first key point and the second key point on the human body in the lateral directions on the image; and
determine, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

According to an example aspect of the present invention, it is provided a program causing a computer to function as:
a skeleton structure detection means for detecting a plurality of key points on a human body included in an image;
a reference information generation means for generating, based on the plurality of key points, reference information indicating a height of the human body or a length of a predetermined part of the human body;
a reference value calculation means for calculating, based on the reference information, a reference value indicating a distance between a first key point and a second key point on the human body in lateral directions on the image in a case where the human body has appeared in the image in a predetermined orientation;
an actual measurement value calculation means for calculating, based on the plurality of key points, an actual measurement value indicating a distance between the first key point and the second key point on the human body in the lateral directions on the image; and
an orientation determination means for determining, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

### Advantageous Effects of Invention

According to the example aspects of the present invention, a processing device, a processing method, and a program for more finely determining an orientation of a human body in a technique for determining an orientation of a human body based on data indicating positions of a plurality of key points on a person are achieved.

### BRIEF DESCRIPTION OF DRAWINGS

The above-described object and other objects, features, and advantages will be further clarified by the following preferable example embodiments and accompanying drawings.

FIG. 1 It is a diagram illustrating an example of a functional block diagram of a processing device.

FIG. 2 It is a diagram illustrating an example of a hardware configuration of the processing device.

FIG. 3 It is a diagram illustrating an example of key points on a human body, which are to be detected.

FIG. 4 It is a diagram illustrating an example of the key points on the human body, which have been detected.

FIG. 5 It is a diagram illustrating processing of determining an orientation of a human body on an image.

FIG. 6 It is another diagram illustrating processing of determining the orientation of the human body on the image.

FIG. 7 It is a flowchart illustrating an example of a flow of processing of the processing device.

FIG. 8 It is a diagram illustrating another example of the functional block diagram of the processing device.

FIG. 9 It is a diagram illustrating processing of determining an orientation of a detection target on an image.

FIG. 10 It is a diagram illustrating still another example of the functional block diagram of the processing device.

### EXAMPLE EMBODIMENT

Hereinafter, example embodiments of the present invention will be described with reference to the drawings. In all the drawings, the same components are denoted by the same reference numerals, and description thereof will be omitted as appropriate.

### First Example Embodiment

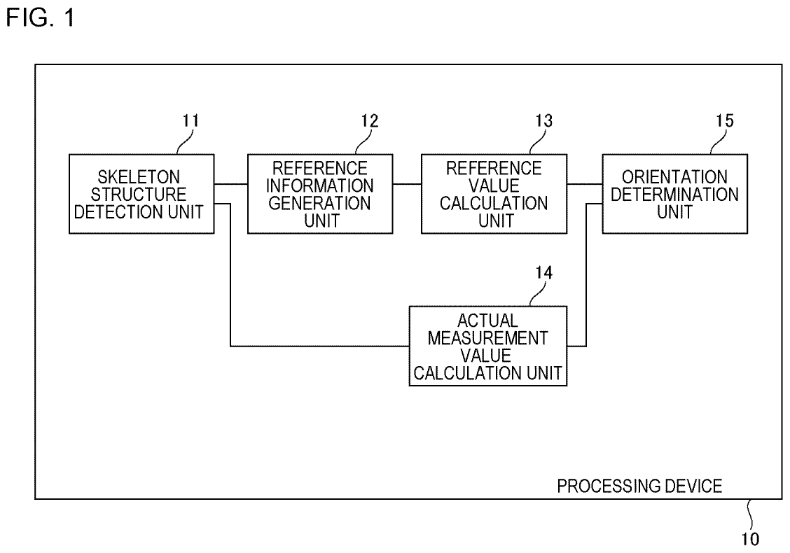

FIG. 1 is a functional block diagram illustrating an outline of a processing device 10 according to a first example embodiment. The processing device 10 includes a skeleton structure detection unit 11, a reference information generation unit 12, a reference value calculation unit 13, an actual measurement value calculation unit 14, and an orientation determination unit 15.

The skeleton structure detection unit 11 detects a plurality of key points on a human body included in an image.

The reference information generation unit 12 generates, based on the plurality of key points that the skeleton structure detection unit 11 has detected, reference information indicating a height of the human body or a length of a predetermined part of the human body.

The reference value calculation unit 13 calculates, based on the reference information that the reference information generation unit 12 has generated, a reference value indicating a distance between a first key point and a second key point on the human body in lateral directions on the image in a case where the human body has appeared in the image in a predetermined orientation.

The actual measurement value calculation unit 14 calculates, based on the plurality of key points that the skeleton structure detection unit 11 has detected, an actual measurement value indicating a distance between the first key point and the second key point on the human body in the lateral directions on the image.

The orientation determination unit 15 determines, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

With the processing device 10 according to the first example embodiment as described above, it is possible to more finely determine an orientation of a human body in a technique for determining an orientation of a human body based on data indicating positions of a plurality of key points on a person.

### Second Example Embodiment

### “Outline”

The processing device 10 according to a second example embodiment is obtained by embodying the processing device 10 according to the first example embodiment. Hereinafter, a configuration of the processing device 10 will be described in detail.

### “Hardware Configuration”

An example of a hardware configuration of the processing device 10 will be described. Each functional unit of the processing device 10 is implemented by any combination of hardware and software. It is to be understood by those skilled in the art that there are various modifications of an implementation method and the device. The software includes a program stored in advance from a stage of shipping the device, a program downloaded from a recording medium such as a compact disc (CD), a server on the Internet, or the like.

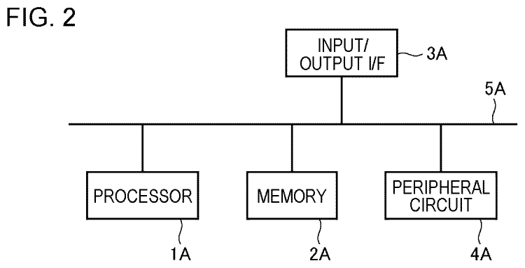

FIG. 2 is a block diagram illustrating the hardware configuration of the processing device 10. As illustrated in FIG. 2, the processing device 10 includes a processor 1A, a memory 2A, an input/output interface 3A, a peripheral circuit 4A, and a bus 5A. The peripheral circuit 4A includes various modules. The processing device 10 may not include the peripheral circuit 4A. The processing device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is, for example, an arithmetic processing unit such as a central processing unit (CPU) or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, a camera and the like, and an interface for outputting information to an output device, an external device, an external server, and the like. The input/output interface 3A includes an interface for connection to a communication network such as the Internet. The input device is, for example, a keyboard, a mouse, a microphone, a physical button, a touch panel, or the like. The output device is, for example, a display, a speaker, a printer, a mailer, or the like. The processor 1A can issue a command to each module and execute calculation based on a calculation result.

### “Functional Configuration”

Next, a functional configuration of the processing device 10 according to the present example embodiment will be described in detail. FIG. 1 illustrates an example of the functional block diagram of the processing device 10 according to the present example embodiment. As illustrated, the processing device 10 according to the present example embodiment includes the skeleton structure detection unit 11, the reference information generation unit 12, the reference value calculation unit 13, the actual measurement value calculation unit 14, and the orientation determination unit 15.

The skeleton structure detection unit 11 detects a plurality of key points on a human body included in an image.

The term “image” refers to a concept including still image and moving image. A moving image includes a plurality of time-series frame images.

The skeleton structure detection unit 11 detects an N (N is an integer of equal to or more than 2) number of key points on the human body included in the image. In a case where a moving image is a processing target, the skeleton structure detection unit 11 performs processing of detecting key points for each frame image. The skeleton structure detection unit 11 detects the N number of key points by utilizing a skeleton estimation technique such as OpenPose. A skeleton structure of a human body, which the technique detects, includes “key points” indicating feature points such as joints and “bones (bone links)” indicating links among the key points.

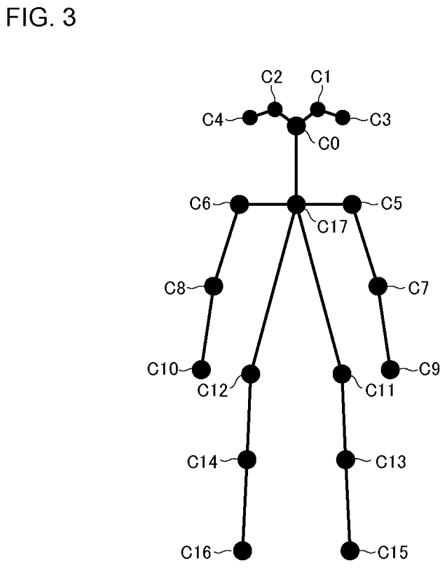

FIG. 3 illustrates an example of a skeleton structure of a human body, which the skeleton structure detection unit 11 detects. The skeleton structure detection unit 11 uses a skeleton estimation technique such as OpenPose to detect a skeleton structure of a human body as illustrated in FIG. 3 from a two-dimensional image.

The skeleton structure detection unit 11 extracts, for example, feature points that may be key points from the image, refers to information acquired as images of key points have been allowed to undergo machine learning, and detects the N number of key points on the human body. The N number of key points to be detected is determined in advance. The number of key points to be detected (that is, an N number) and which parts of a human body are to be used as key points to be detected vary, and it is possible to adopt a desired variation.

In the present example embodiment, as illustrated in FIG. 3, it is assumed that 18 (N=18) key points are set as detection targets. The 18 key points include a nose C0, a left eye C1, a right eye C2, a left ear C3, a right ear C4, a left shoulder C5, a right shoulder C6, a left elbow C7, a right elbow C8, a left hand C9, a right hand C10, a left waist C11, a right waist C12, a left knee C13, a right knee C14, a left foot C15, a right foot C16, and a neck C17.

Now back to FIG. 1, the reference information generation unit 12 generates reference information based on the plurality of key points that the skeleton structure detection unit 11 has detected.

The “reference information” indicates a height of a human body appearing in an image or a length of a predetermined part of the human body.

The term “predetermined part of a human body” refers to a part having a length having a strong correlation with the height of the human body. A predetermined part of a human body is, for example, but not limited to, a torso, a leg, or an arm.

The reference information indicates the height of the human body or the length of the predetermined part of the human body as a length on an image. For example, the height of the human body and the length of the predetermined part of the human body are indicated as a number of pixels or a distance in a coordinate system set on an image (distance between two points in the coordinate system), for example. Such reference information is calculated by using a desired technique. For example, a technique that may be utilized is, but not limited to, one of the techniques disclosed in PTL 2 and PTL 3.

The reference value calculation unit 13 calculates a reference value based on the reference information that the reference information generation unit 12 has generated.

A “reference value” indicates a distance between a first key point and a second key point on a human body in lateral directions on an image in a case where the human body having the height or the length of the predetermined part, which the reference information indicates, appears in the image in a predetermined orientation. The distance is indicated as the number of pixels or a length on an image such as a distance in a coordinate system set on the image (distance between two points in the lateral directions in the coordinate system).

The term “predetermined orientation” is a design matter. The predetermined orientation used in the present example embodiment refers to an orientation of directly facing the camera.

The term “first key point and second key point” refers to two of the N number of key points on a detection target, which have been described above. Two key points that are respectively present on both sides with a center of the human body interposed and that form a pair with each other are utilized as the first key point and the second key point.

The first key point and the second key point are, for example, any of examples described below.
(1) Left eye C1 and right eye C2
(2) Left ear C3 and right ear C4
(3) Left shoulder C5 and right shoulder C6
(4) Left elbow C7 and right elbow C8
(5) Left hand C9 and right hand C10
(6) Left waist C11 and right waist C12
(7) Left knee C13 and right knee C14
(8) Left foot C15 and right foot C16

Among the examples described above, it is preferable to utilize, as the first key point and the second key point, any one of (1), (2), (3), and (6) having a relatively small degree of freedom in distance between the first key point and the second key point. In the present example embodiment, as described below, a degree of lateral orientation of a human body on an image is determined based on a distance between a first key point and a second key point of the human body in the lateral directions on the image. Utilization of key points between which a distance may vary due to a factor other than an orientation of a human body is not preferable.

Processing of calculating, based on the height of a human body or the length of a predetermined part of the human body, which reference information indicates, a reference value indicating a distance between a first key point and a second key point on the human body in the lateral directions on an image in a case where the human body has appeared in the image in a predetermined orientation will now be described herein.

A calculation model for calculating a reference value from reference information is generated in advance and stored in the processing device 10. The reference value calculation unit 13 calculates a reference value based on the calculation model.

A configuration of the calculation model varies. A conceivable simple calculation model calculates, as a reference value, a value acquired by multiplying the height of a human body or the length of a predetermined part of the human body, which reference information indicates, by a predetermined correction coefficient. The correction coefficient is determined in advance based on a relationship (ratio) between “the height of a human body or the length of a predetermined part of the human body” and “a distance between a first key point and a second key point in the lateral directions” in a case where the human body has appeared in an image in a predetermined orientation (for example, an orientation directly facing a camera). Although the relationship may vary for each human body, its difference is small and may be generalized. For example, a plurality of human bodies may be regarded as investigation targets, and such a ratio as described above may be calculated for each of the human bodies. A statistical value (average value, most frequent value, or median value) of the ratios of the plurality of human bodies may be used as the correction coefficient described above. The calculation model exemplified in here is a mere example, and the present invention is not limited to use the calculation model described in here.

The actual measurement value calculation unit 14 calculates, based on the plurality of key points that the skeleton structure detection unit 11 has detected, an actual measurement value indicating a distance between the first key point and the second key point on the human body in the lateral directions on the image.

An “actual measurement value” is indicated as the number of pixels or a length on an image such as a distance in a coordinate system set on the image (distance between two points in the coordinate system).

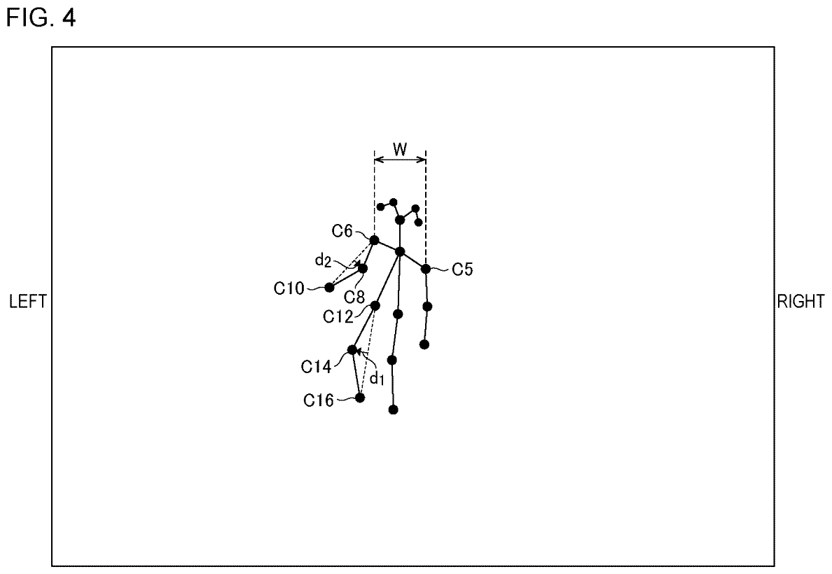

FIG. 4 illustrates an example of a distance W in the lateral directions, which is to be calculated. In the illustrated example, the key point C5 and the key point C6 are respectively used as a first key point and a second key point. A “distance in the lateral directions” refers to a distance at which a first key point and a second key point are away from each other in the lateral directions of an image, which does not include a distance component in longitudinal directions. For example, in a case where coordinates of a first key point are expressed as (x₁, y₁) and coordinates of a second key point are expressed as (x₂, y₂), in a coordinate system where the lateral directions of an image correspond to x-axis directions and the longitudinal directions of the image correspond to y-axis directions, an absolute value of (x₁−x₂) indicates a distance in the lateral directions.

Now back to FIG. 1, the orientation determination unit 15 determines whether the orientation of the human body on the image is one of a plurality of orientations.

An “orientation of a human body” indicates an orientation of a predetermined part of the body. For example, an orientation of a face or an orientation of a torso (orientation of a belly) is defined as an orientation of a human body.

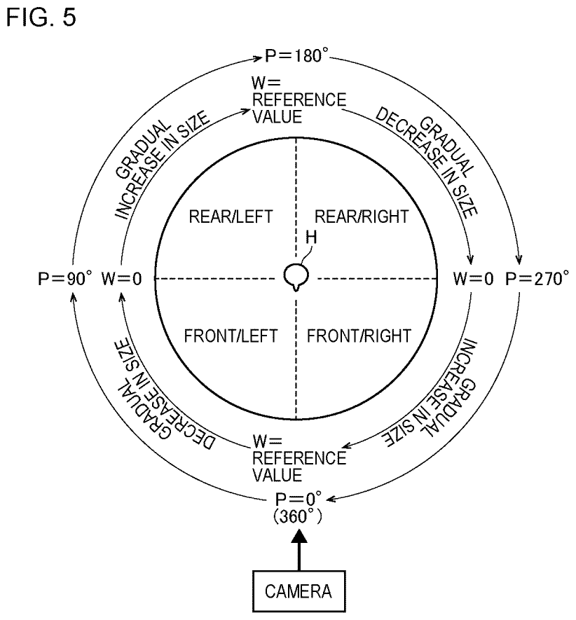

An “orientation of a human body on an image” is represented by an angle P as illustrated in FIG. 5. The angle P takes, in a case where a first orientation is defined as 0°, a value ranging from 0° and 360° inclusive. FIG. 5 illustrates a situation where a human body H (human body included in an image) that is an imaging target and a camera that images the human body H are observed from above.

In the illustrated example, a state where the human body H directly faces the camera is defined as P=0°. From this state, a state where the human body H turns 90° in a left direction as viewed from the camera, that is, fully faces a side (left as viewed from the camera) is defined as P=90°. From this state, a state where the human body H further turns 90° in the same direction, that is, turns his or her back on the camera is defined as P=180°. From this state, a state where the human body H further turns 90° in the same direction, that is, fully faces another side (right as viewed from the camera) is defined as P=270°.

The orientation determination unit 15 determines whether the orientation of the human body H on the image is one of the plurality of orientations, which is represented by the angle P described above. Orientations may be defined in 360 types each in an increment of 1°. Orientations may be defined in 360/n₁ types each in an increment of n₁° (n is larger than 1). Orientations may be defined in 360/n₂ types each in an increment of n₂° (n is larger than 0 and smaller than 1).

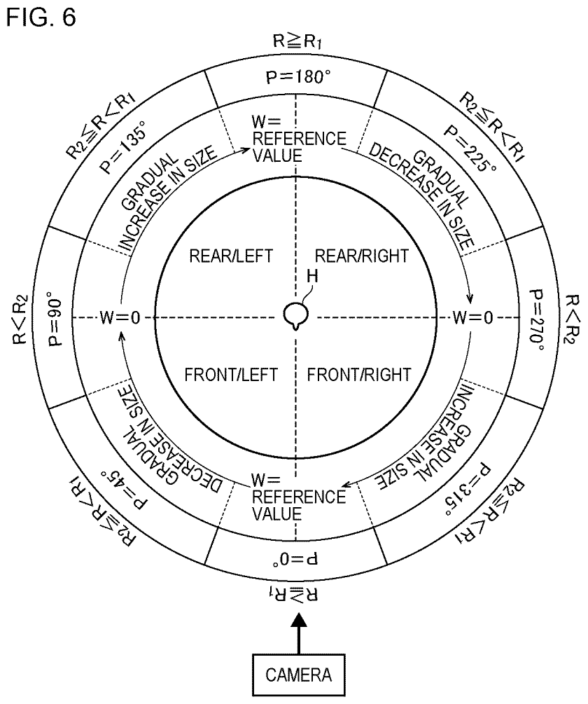

FIG. 6 illustrates an example of definitions of a plurality of orientations. In the illustrated example, orientations are defined in eight types each in an increment of 45°. A representative value of the angle P is associated with each of the orientations That is, the orientations are defined in eight types respectively with the representative values of P=0°, 45°, 90°, 135°, 180°, 225°, 270°, and 315°. In the case of this example, the orientation determination unit 15 determines whether the orientation of the human body H on the image is one of the orientations of the eight types.

The plurality of orientations are identified from each other based on “whether a human body is in a frontward orientation or a rearward orientation”, “whether the human body is in a rightward orientation or a leftward orientation”, and “a degree of lateral orientation of the human body”. That is, the orientation determination unit 15 determines whether a human body included in an image is in “the frontward orientation or the rearward orientation”, “the rightward orientation or the leftward orientation”, and “a degree of lateral orientation”. The orientation determination unit 15 determines, based on a result of the determination, whether the orientation of the human body on the image is one of the plurality of orientations described above.

The orientation determination unit 15 performs the determination based on “the reference value that the reference value calculation unit 13 has calculated”, “the actual measurement value that the actual measurement value calculation unit 14 has calculated”, and “a positional relationship between a key point on the right side part of the human body and a key point on the left side part of the human body on the image”. Details will be described below.

### -Determination of Whether Human Body is in Frontward Orientation or Rearward Orientation-

As illustrated in FIG. 6, the “frontward orientation” refers to a state where the human body H faces the camera. The “rearward orientation” refers to a state where the human body H turns his or her back on the camera.

The orientation determination unit 15 determines, based on a relative positional relationship between the key point on the right side part and the key point on the left side part of the human body, which are paired with each other, in the left and right directions on the image, whether the human body is in the frontward orientation or the rearward orientation on the image.

A “key point on the right side part and a key point on the left side part of the human body, which are paired with each other” are, for example, any of examples described below.
(1) Left eye C1 and right eye C2
(2) Left ear C3 and right ear C4
(3) Left shoulder C5 and right shoulder C6
(4) Left elbow C7 and right elbow C8
(5) Left hand C9 and right hand C10
(6) Left waist C11 and right waist C12
(7) Left knee C13 and right knee C14
(8) Left foot C15 and right foot C16

It is difficult to detect the key points of (1) in a case where the human body having turned his or her back on the camera is imaged. It is preferable to utilize any one of (2) to (8).

A “relative positional relationship in the left and right directions on an image” refers to a fact that one is positioned on the right side (or the left side) on the image.

In a case where the human body is in the frontward orientation, as illustrated in FIG. 4, the key point (right shoulder C6, for example) on the right side part is positioned nearer the left side of the image than the key point (left shoulder C5, for example) on the left side part. In a case where the human body is in the rearward orientation, although not illustrated, on the other hand, the key point (right shoulder C6, for example) on the right side part is positioned nearer the right side of the image than the key point (left shoulder C5, for example) on the left side part.

The orientation determination unit 15 determines, based on such a relationship as described above, whether the human body is in the frontward orientation or the rearward orientation on the image. Specifically, the orientation determination unit 15 determines that, in a case where the key point (right shoulder C6, for example) on the right side part is positioned nearer the left side of the image than the key point (left shoulder C5, for example) on the left side part, the human body is in the frontward orientation. On the other hand, the orientation determination unit 15 determines that, in a case where the key point (right shoulder C6, for example) on the right side part is positioned nearer the right side of the image than the key point (left shoulder C5, for example) on the left side part, the human body is in the rearward orientation.

### -Determination of Whether Human Body is in Rightward Orientation or Leftward Orientation-

As illustrated in FIG. 6, the “rightward orientation” refers to a state where the human body faces rightward as viewed from the camera. The “leftward orientation” refers to a state where the human body faces in the left direction as viewed from the camera.

The orientation determination unit 15 determines, based on at least one of conditions described below, whether the human body is in the rightward orientation or the leftward orientation on the image:
Whether a key point on the right side part of the human body and a key point on the left side part of the human body have been detected in detection of a plurality of key points.
Orientation of an elbow indicated by a plurality of key points.
Orientation of a knee indicated by a plurality of key points.

### (Determination Based on Whether a Key Point on the Right Side Part of the Human Body and a Key Point on the Left Side Part of the Human Body Have Been Detected in Detection of a Plurality of Key Points)

A “key point on the right side part of the human body” is, for example, the right eye C2, the right ear C4, the right shoulder C6, the right elbow C8, the right hand C10, the right waist C12, the right knee C14, or the right foot C16. A “key point on the left side part of the human body” is, for example, the left eye C1, the left ear C3, the left shoulder C5, the left elbow C7, the left hand C9, the left waist C11, the left knee C13, or the left foot C15.

In a case where an image is captured in a state where the human body is in the rightward orientation (in a state where the human body faces “Rear/right” or “Front/right” in FIG. 6), the left side part of the human body may be easily hidden by another part of the human body on the image. As a result, it may be difficult to detect the key point on the left side part of the human body in detection processing that the skeleton structure detection unit 11 performs. In a case where an image is captured in a state where the human body is in the leftward orientation (in a state where the human body faces “Rear/left” or “Front/left” in FIG. 6), on the other hand, the right side part of the human body may be easily hidden by another part of the human body on the image. As a result, it may be difficult to detect the key point on the right side part of the human body in the detection processing that the skeleton structure detection unit 11 performs.

The orientation determination unit 15 is able to determine, based on such a relationship as described above, whether the human body is in the rightward orientation or the leftward orientation on the image.

In a case where one of the key points on the right side part of the human body is undetected, as an example, the orientation determination unit 15 is able to determine that the human body is in the leftward orientation. In a case where one of the key points on the left side part of the human body is undetected, the orientation determination unit 15 is able to determine that the human body is in the rightward orientation.

As another example, the orientation determination unit 15 may count a number of key points that have not been detected among each of the key points on the right side part of the human body and the key points on the left side part of the human body. In a case where the number of key points that have not been detected on the right side part of the human body is larger than the number of key points that have not been detected on the left side part of the human body, the orientation determination unit 15 may determine that the human body is in the leftward orientation. In a case where the number of key points that have not been detected on the left side part of the human body is larger than the number of key points that have not been detected on the right side part of the human body, the orientation determination unit 15 may determine that the human body is in the rightward orientation.

### (Determination Based on an Orientation of an Elbow Indicated by a Plurality of Key Points)

An “orientation of an elbow” refers to an orientation that a convex-shaped surface formed when an elbow is bent faces. Due to a skeleton structure of a human body, an orientation of an elbow tends to be opposite to an orientation of the human body (such as an orientation of the face). The orientation determination unit 15 is able to determine, based on such a relationship as described above, whether the human body is in the rightward orientation or the leftward orientation on the image.

Specifically, the orientation determination unit 15 determines that, in a case where an elbow of the human body is in the rightward orientation, the human body is in the leftward orientation. The orientation determination unit 15 determines that, in a case where an elbow of the human body is in the leftward orientation, the human body is in the rightward orientation.

It is possible to define an orientation of an elbow as, for example, an orientation that a desired point (for example, a middle point) on a line segment connecting the key points of a shoulder and a hand faces the key point of the elbow. The orientation determination unit 15 is able to determine, based on the definition, an orientation of an elbow of the human body on an image. In the example illustrated in FIG. 4, an orientation of the right elbow corresponds to an orientation d2 that a desired point on a line segment connecting the right shoulder C6 and the right hand C10 faces the right elbow C8. From the drawing, an orientation of the right elbow is in the rightward orientation in the case of this example. The orientation determination unit 15 determines that the human body is in the leftward orientation.

### (Determination Based on an Orientation of a Knee Indicated by a Plurality of Key Points)

An “orientation of a knee” refers to an orientation that a convex-shaped surface formed when a knee is bent faces. Due to the skeleton structure of a human body, an orientation of a knee tends to be identical to an orientation of the human body (such as an orientation of the face). The orientation determination unit 15 is able to determine, based on such a relationship as described above, whether the human body is in the rightward orientation or the leftward orientation on the image.

Specifically, the orientation determination unit 15 determines that, in a case where a knee of the human body is in the rightward orientation, the human body is in the rightward orientation. The orientation determination unit 15 determines that, in a case where a knee of the human body is in the leftward orientation, the human body is in the leftward orientation.

It is possible to define an orientation of a knee as, for example, an orientation that a desired point (for example, a middle point) on a line segment connecting the key points of a waist and a foot faces the key point of the elbow. The orientation determination unit 15 is able to determine, based on the definition, an orientation of a knee of the human body on an image. In the example illustrated in FIG. 4, an orientation of the right knee corresponds to an orientation dl that a desired point on a line segment connecting the right waist C12 and the right foot C16 faces the right knee C14. From the drawing, an orientation of the right knee is in the leftward orientation in the case of this example. The orientation determination unit 15 determines that the human body is in the leftward orientation.

### -Determination of a Degree of Lateral Orientation of the Human Body-

The orientation determination unit 15 determines, based on a magnitude of an actual measurement value with respect to the reference value, a degree of lateral orientation of the human body on an image.

As described above, a “reference value” indicates a distance between a first key point and a second key point in the lateral directions on an image in a case where a human body having the height or the length of a predetermined part, which the reference information indicates, appears in the image in a predetermined orientation. The “predetermined orientation” used in the present example embodiment refers to an orientation directly facing the camera.

As described above, an “actual measurement value” indicates an actual distance between the first key point and the second key point on the human body in the lateral directions on the image.

The first key point and the second key point are as described above.

The actual distance between the first key point and the second key point in the lateral directions on the image varies depending on an orientation of the human body. In a case where the human body H directly faces the camera (P=0°) or in a case where the human body H directly faces 180° opposite to the camera (in a case where the human body H has turned his or her back on the camera, P=180°), as illustrated in FIG. 6, an actual distance W between the first key point and the second key point in the lateral directions on the image becomes maximum. In the present example embodiment in which the “predetermined orientation” is defined as an orientation directly facing the camera, the distance W at this time is defined as the reference value.

The distance W decreases as the human body H further turns in one of the lateral directions from the position. The distance W becomes zero when the human body fully faces the side.

The orientation determination unit 15 determines, based on such a relationship as described above, a degree of lateral orientation of the human body. For example, the orientation determination unit 15 is able to determine a degree of lateral orientation based on a value R (=(actual measurement value)/(reference value)) indicating a magnitude of an actual measurement value with respect to the reference value. In the case of this example, the larger the value of R, the smaller the degree of lateral orientation, and the smaller the value of R, the larger the degree of lateral orientation.

### -Determination of Whether an Orientation is One of a Plurality of Orientations-

The orientation determination unit 15 first identifies which one of four classes illustrated in FIG. 5 an orientation of the human body corresponds to based on a result of the determination of whether the human body is in the frontward orientation or the rearward orientation and a result of the determination of whether the human body is in the rightward orientation or the leftward orientation. The four classes are “Front/leftward orientation”, “Back/leftward orientation”, “Front/rightward orientation”, and “Back/rightward orientation”.

The orientation determination unit 15 determines which of the identified classes the orientation corresponds to based on a result of the determination of the degree of lateral orientation (the value of R described above).

Description will be given in more detail with reference to the specific example illustrated in FIG. 6. In the example illustrated in FIG. 6, the orientations are defined in eight types each in an increment of 45° as an orientation of the human body on an image. A representative value of the angle P is indicated for each of the orientations. That is, the orientations are defined in eight types respectively with the representative values of P=0°, 45°, 90°, 135°, 180°, 225°, 270°, and 315°. A range of numerical values, one of which R (=(actual measurement value)/(reference value)) may take, in a case where the human body has appeared in an image in each of the orientations, is associated with each of the orientations. For the orientations in two types respectively with the representative values of P=0° and 180°, R≥R1 is associated. For the orientations in two types respectively with the representative values of P=90° and 270°, R<R₂ is associated. For the orientations in four types respectively with the representative values of P=45°, 135°, 225°, and 315°, R₂≤R<R₁ is associated. Information indicating the relationship illustrated in FIG. 6 is stored in advance in the processing device 10.

It is assumed that, for example, the orientation determination unit 15 has identified that, based on a result of the determination of whether the orientation is the frontward orientation or the rearward orientation and a result of the determination of whether the orientation is the rightward orientation or the leftward orientation, the orientation of the human body corresponds to “Front/leftward orientation” in the four classes illustrated in FIG. 6. According to FIG. 6, “Front/leftward orientation” includes the orientations in three types respectively with the representative values of P=0°, 45°, and 90°. The orientation determination unit 15 determines, based on the value of R, whether the orientation of the human body corresponds to one of the orientations in three types. Specifically, the orientation determination unit 15 determines whether the value of R is included in one of the ranges of the numerical values of R, which respectively correspond to the orientations in three types. The orientation determination unit 15 determines the orientation including the value of R as the orientation of the human body on the image.

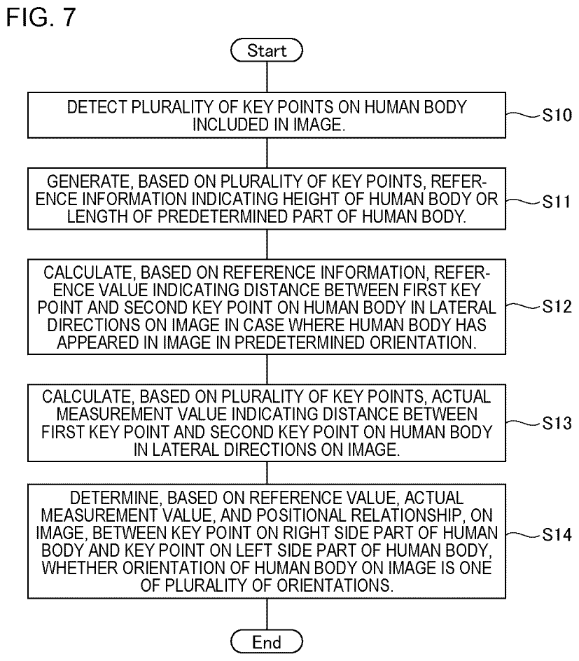

Next, an example of a flow of processing of the processing device 10 will be described with reference to the flowchart of FIG. 7.

The processing device 10 first detects a plurality of key points on a human body included in an image (S10).

Next, the processing device 10 generates, based on the plurality of key points detected at S10, reference information indicating the height of the human body or the length of a predetermined part of the human body (S11).

Next, the processing device 10 calculates a reference value indicating a distance between a first key point and a second key point on the human body in the lateral directions on the image in a case where the human body having the height or the length of the predetermined part of the human body, which the reference information generated at S11 indicates, has appeared in the image in a predetermined orientation (S12).

Next, the processing device 10 calculates, based on the plurality of key points detected at S10, an actual measurement value indicating the distance between the first key point and the second key point on the human body in the lateral directions on the image (S13).

The processing device 10 determines, based on the reference value calculated at S12, the actual measurement value calculated at S13, and a positional relationship between a key point on the right side part of the human body and a key point on the left side part of the human body on the image, whether the orientation of the human body on the image is one of the plurality of orientations (S14). The orientation of the human body on the image is represented by an angle P ranging from 0° to 360° inclusive. Although not illustrated, the processing device 10 is able to output a result of the determination via a predetermined output device. The output device is, for example, but not limited to, a display, a projection device, or a speaker.

### “Operations and Effects”

With the processing device 10 according to the present example embodiment, it is possible to more finely determine an orientation of a human body in a technique for determining an orientation of a human body based on data indicating positions of a plurality of key points on a person. Specifically, with the processing device 10, it is possible to determine the orientation of the human body on the image as one of a plurality of orientations represented by angles ranging from 0° to 360° inclusive. With the processing device 10 that makes it possible to more finely determine an orientation of a human body as described above, a technique for determining an orientation of a human body based on data indicating the positions of a plurality of key points on a person expands in versatility.

The processing device 10 is able to determine the orientation of the human body on the image based on a result of determination of whether the human body is in the frontward orientation or the rearward orientation, whether the human body is in the rightward orientation or the leftward orientation, and a degree of lateral orientation of the human body. With the processing device 10 described above, it is possible to determine the orientation of the human body on the image more finely and with high accuracy.

The processing device 10 is able to determine whether the human body is in the frontward orientation or the rearward orientation on the image based on a relative positional relationship between a key point on the right side part and a key point on the left side part of the human body, which are paired with each other, in the left and right directions on the image. With the processing device 10 described above, it is possible to determine whether the human body is in the frontward orientation or the rearward orientation on the image with high accuracy with relatively simple computer processing.

The processing device 10 is able to determine whether the human body is in the rightward orientation or the leftward orientation on the image based on at least one of a “result of detection of a key point on the right side part and a key point on the left side part”, an “orientation of an elbow”, and an “orientation of a knee”. With the processing device 10 described above, it is possible to determine whether the human body is in the rightward orientation or the leftward orientation on the image with high accuracy with relatively simple computer processing.

The processing device 10 is able to determine a degree of lateral orientation of the human body on the image based on a magnitude of an actual measurement value with respect to the reference value. A “reference value” refers to a theoretical value of a distance between first and second key points in the lateral directions on an image in a case where a human body having the height or the length of a predetermined part of the body, which corresponds to a predetermined value, appears in the image in a predetermined orientation. An “actual measurement value” refers to an actual measurement value of the distance between the first and second key points in the lateral directions on the image in a case where the human body having the height or the length of the predetermined part of the body, which corresponds to the predetermined value, appears in the image in the predetermined orientation. With the processing device 10 described above, it is possible to determine a degree of lateral orientation of a human body on an image with high accuracy with relatively simple computer processing.

### Third Example Embodiment

The processing device 10 according to the present example embodiment performs detection of a predetermined detection target included in an image, in addition to detection of an orientation of a human body. The processing device 10 determines, based on a result of the detection, a relationship between the human body and the predetermined detection target. Details will be described below.

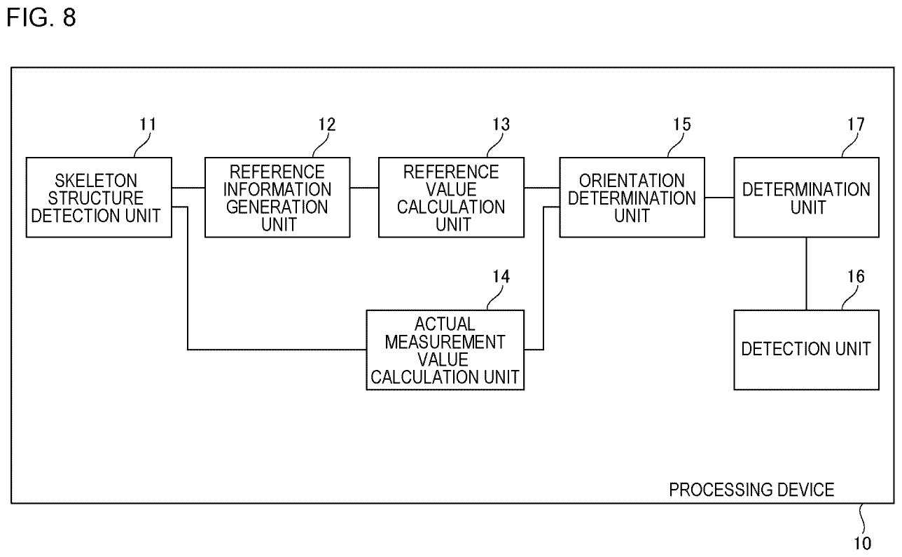

FIG. 8 illustrates an example of a functional block diagram of the processing device 10 according to the present example embodiment. As illustrated, the processing device 10 according to the present example embodiment includes the skeleton structure detection unit 11, the reference information generation unit 12, the reference value calculation unit 13, the actual measurement value calculation unit 14, the orientation determination unit 15, a detection unit 16, and a determination unit 17.

The detection unit 16 detects a detection target included in an image. The detection unit 16 outputs information indicating at least one of a position and an orientation of the detection target that has been detected on the image.

The “image” refers to an image from which the skeleton structure detection unit 11 has detected a plurality of key points on a human body. That is, for one image, processing through which the skeleton structure detection unit 11 detects a plurality of key points on the human body and processing through which the detection unit 16 detects a detection target are performed.

It is possible to determine a “detection target” in accordance with a utilization situation of the processing device 10. For example, it is possible to set, as a detection target, an object that is subject to processing for a person, such as a vending machine, a digital signage, an automatic door, or a display shelf.

The “position of the detection target on the image” is indicated by using, for example, coordinates in a two-dimensional coordinate system set on the image. The detection unit 16 may generate a three-dimensional image by estimating depth information from a two-dimensional image. The detection unit 16 may indicate the position of the detection target on the image by using coordinates in a three-dimensional coordinate system set on the three-dimensional image. Generation of a three-dimensional image from a two-dimensional image is achieved by utilizing a desired technique.

The “orientation of the detection target on the image” indicates an orientation of a main surface of the detection target. Although a determination of setting which surface of the detection target as the main surface varies, it is possible to set, for example, a surface facing the person as the main surface. In a case of a vending machine, for example, a surface on which products are displayed and a money insertion port is provided is defined as the main surface. In a case of a digital signage, for example, a surface on which a display is present and information is displayed is defined as the main surface. In a case of an automatic door, for example, an opening/closing surface of the door through which a user enters or exits is defined as the main surface. In a case of a display shelf, for example, a surface facing a customer in a state where products are displayed is defined as the main surface.

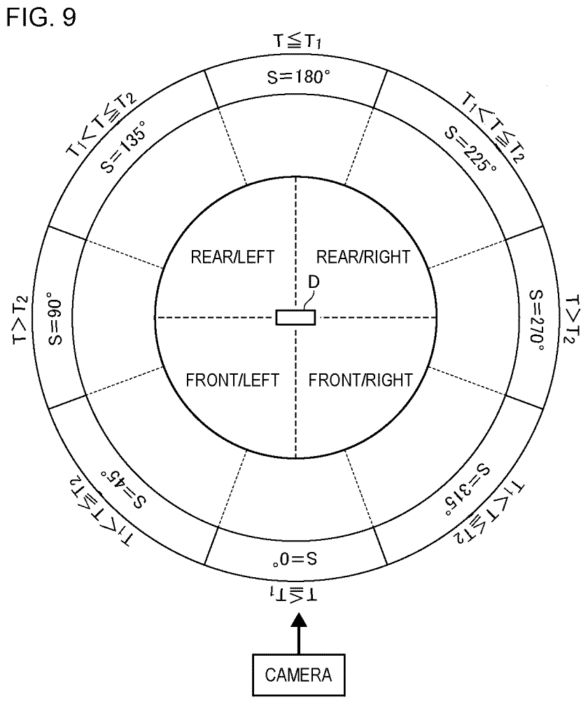

It is possible to detect an orientation of the detection target on an image by using, for example, a method identical to the method for an orientation of a human body on an image, which has been described in the second example embodiment. That is, an orientation of the detection target on the image is represented by an angle S ranging from 0° to 360° inclusive. In the case of this example, information indicating a relationship illustrated in FIG. 9 is stored in advance in the processing device 10. The detection unit 16 identifies, based on the information, an orientation of the detection target.

The detection unit 16 is able to determine whether an object that is the detection target is in the frontward orientation, the rearward orientation, the rightward orientation, or the leftward orientation by using image analysis. For example, the detection unit 16 is able to determine, based on a learning model generated through machine learning by using, as learning data, images of a detection target in various orientations, whether the detection target appearing in the image is in the frontward orientation, the rearward orientation, the rightward orientation, or the leftward orientation.

The detection unit 16 is able to determine, based on an aspect ratio T (=(horizontal length)/(vertical length)), on the image, of the main surface of the detection target, a degree of lateral orientation of the main surface of the detection target. The smaller the aspect ratio T, the smaller the degree of lateral orientation of the main surface of the detection target. The larger the aspect ratio T, the larger the degree of lateral orientation of the main surface of the detection target.

In the example illustrated in FIG. 9, orientations are defined in eight types each in an increment of 45° as orientations of a detection target on an image. A representative value of the angle S is indicated for each of the orientations. That is, the orientations are defined in eight types respectively with the representative values of S=0°, 45°, 90°, 135°, 180°, 225°, 270°, and 315°. A range of numerical values, one of which the aspect ratio T may take, in a case where the detection target has appeared in an image in each of the orientations, is associated with each of the orientations. For the orientations in two types respectively with the representative values of S=0° and 180°, T≤T₁ is associated. For the orientations in two types respectively with the representative values of T=90° and 270°, T>T₂ is associated. For the orientations in four types respectively with the representative values of S=45°, 135°, 225°, and 315°, T₁<T≤T₂ is associated.

It is assumed that, for example, the detection unit 16 has identified that, based on a result of the determination of whether the orientation is the frontward orientation or the rearward orientation and a result of the determination of whether the orientation is the rightward orientation or the leftward orientation, the orientation of the detection target corresponds to “Front/leftward orientation” in the four classes illustrated in FIG. 9. According to FIG. 9, “Front/leftward orientation” includes the orientations in three types respectively with the representative values of S=0°, 45°, and 90°. The detection unit 16 determines, based on the value of T, whether the orientation of the detection target corresponds to one of the orientations in three types. Specifically, the detection unit 16 determines whether the value of T is included in one of the ranges of the numerical values of T, which respectively correspond to the orientations in three types. The detection unit 16 determines the orientation including the value of T as the orientation of the detection target on the image.

Although, in FIG. 9, the orientations in eight types each in an increment of 45° are defined, the present invention is not limited to the example. There may be cases where shapes of detection targets have been normalized. In such a case, it is possible to identify in advance such a relationship as illustrated in FIG. 9 for each detection target and store the identified relationship in the processing device 10.

Now back to FIG. 8, the determination unit 17 determines, based on the orientation of the human body on the image and the position of the detection target on the image, an action of the human body with respect to the detection target. In a case where there is a detection target in a direction in which a human body faces, for example, the determination unit 17 is able to determine that “the human body is facing the detection target”. The determination may be achieved based on, for example, a three-dimensional image generated by estimating depth information from a two-dimensional image.

The determination unit 17 is able to determine, based on the orientation of the human body and the orientation of the detection target on the image, an action of the human body with respect to the detection target. In a case where it is determined that “the human body is facing the detection target”, for example, the determination unit 17 is able to determine from, based on the orientation of the human body and the orientation of the detection target on the image, an angle at which the human body is looking at the detection target. In a case where a difference between the orientation in which the human body faces and the orientation in which the detection target faces (a difference between the angles P and S) is 180°, the determination unit 17 is able to determine that the human body is directly looking at a front of the detection target. The determination unit 17 is able to determine, based on the difference, whether the human body is directly looking at the front of the detection target or is obliquely looking at the detection target, and, in a case where the human body is obliquely looking at the detection target, a degree of obliqueness. The degree of obliqueness is acquired from a degree at which the difference deviates from 180°.

Other configurations of the processing device 10 according to the present example embodiment are similar to those of the first and second example embodiments.

With the processing device 10 according to the present example embodiment, operations and effects similar to those of the first and second example embodiments are implemented. With the processing device 10 according to the present example embodiment, it is possible to determine, based on an orientation of a human body on an image, an action of the human body with respect to a detection target, which has been detected from the image.

Application examples of the processing device 10 according to the present example embodiment will now be described herein.

For example, it is possible to utilize the processing device 10 according to the present example embodiment in a vending machine. A camera is installed in or around the vending machine. The camera captures an image of a person positioned in front of the vending machine. The processing device 10 analyzes the image that the camera has captured and determines an action of the human body appearing in the image with respect to the vending machine. In this case, the camera and the processing device 10 are configured to be communicable with each other. The processing device 10 acquires the image that the camera has generated through real-time processing.

The processing device 10 causes the vending machine to execute processing in accordance with a result of the determination. In a case where it is determined that the human body is facing the vending machine, for example, the processing device 10 may cause the vending machine to output a voice such as “May I help you?”. In a case where it is determined that the human body is facing the vending machine, the processing device 10 may display predetermined information on a display that the vending machine includes. In this case, the processing device 10 and the vending machine are configured to be communicable with each other. The processing device 10 transmits an instruction for causing the vending machine to execute predetermined processing. The vending machine executes the predetermined processing in response to the instruction.

It is possible to perform similar processing by using a digital signage, instead of a vending machine.

As another application example, it is possible to utilize the processing device 10 according to the present example embodiment in an automatic door. A camera is installed around the automatic door. The camera captures an image of a person positioned in front of the automatic door. The processing device 10 analyzes the image that the camera has captured and determines an action of the human body appearing in the image with respect to the automatic door. In this case, the camera and the processing device 10 are configured to be communicable with each other. The processing device 10 acquires the image that the camera has generated through real-time processing.

The processing device 10 causes the automatic door to execute processing in accordance with a result of the determination. In a case where it is determined that the human body is positioned in front of the automatic door and the human body is facing the automatic door, for example, the processing device 10 may cause the automatic door to open the door. In a case where it is determined that the human body is positioned in front of the automatic door but the human body is not facing the automatic door, on the other hand, the processing device 10 may cause the automatic door to not open the door. In a case where such a configuration as described above has been applied, it is possible to suppress such inconvenience that the automatic door is opened in response to a fact that a person who simply passes in front of the automatic door is positioned in front of the automatic door.

In this case, the processing device 10 and the automatic door are configured to be communicable with each other. The processing device 10 transmits an instruction for causing the automatic door to execute predetermined processing (opening or closing of the door). The automatic door executes the predetermined processing in response to the instruction.

As another application example, it is possible to utilize the processing device 10 according to the present example embodiment in a store provided with a display shelf. A camera is installed around the display shelf. The camera captures an image of a person positioned in front of the display shelf. The processing device 10 analyzes the image that the camera has captured and determines an action of the person appearing in the image with respect to the display shelf. In this case, the camera and the processing device 10 are configured to be communicable with each other. The processing device 10 may acquire the image that the camera has generated through real-time processing or batch processing.

The processing device 10 is able to generate market information based on a result of the determination. For example, the processing device 10 is able to aggregate a number of persons facing each display shelf. The processing device 10 is able to aggregate the number of persons facing each display shelf for each environment, such as for each time zone, for each week day, for each month, and for each type of weather. The processing device 10 is able to aggregate, based on attributes of persons, the number of persons of each attribute, who are facing each display shelf. The attributes are, for example, but not limited to, gender, age, and nationality.

The processing device 10 is able to identify the attribute of a person through image analysis.

### Fourth Example Embodiment

The processing device 10 according to the present example embodiment identifies an action of a human body based on time-series changes in orientation of the human body on an image. Details will be described below.

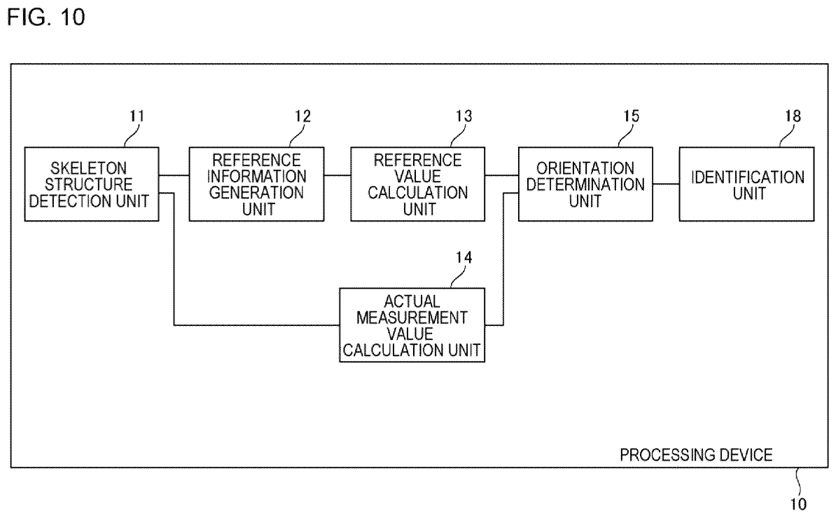

FIG. 10 illustrates an example of a functional block diagram of the processing device 10 according to the present example embodiment. As illustrated, the processing device 10 according to the present example embodiment includes the skeleton structure detection unit 11, the reference information generation unit 12, the reference value calculation unit 13, the actual measurement value calculation unit 14, the orientation determination unit 15, and an identification unit 18.

The identification unit 18 identifies an action of a human body based on time-series changes in orientation of the human body on an image. In association with each of a plurality of actions, features of time-series changes in orientation of a human body when each of the actions is taken have been registered in advance in the processing device 10. The identification unit 18 detects each of the features from time-series changes in orientation of the human body on the image to identify an action of the human body.

An example action is a behavior of looking around. The feature of time-series changes in orientation of the human body, which is specific to this action, is frequent changes in orientation of the human body. The feature is defined, for example, but not limited to, as “changes in orientation occur equal to or greater than a predetermined number of times within a predetermined period of time”.

Another example action is a behavior of looking in one direction. The feature of time-series changes in orientation of the human body, which is specific to this action, is no changes in orientation of the human body. The feature is defined, for example, but not limited to, as “changes in orientation do not occur continuously equal to or more than a predetermined period of time”.

Another example action is a behavior of looking around with only the face without moving the torso. The feature of time-series changes in orientation of the human body, which is specific to this action, is frequent changes in orientation of the face and no changes in orientation of the torso. The feature is defined, for example, but not limited to, as “changes in orientation of the face, which have occurred within a predetermined period of time, are equal to or greater than a first predetermined number of times and changes in orientation of the torso, which have occurred within a predetermined period of time, are equal to or less than a second predetermined number of times”.

In the case of this example, the processing device 10 determines, as orientations of the human body on the image, both an “orientation of the face” and an “orientation of the torso”. Utilizing the left ear C3 and the right ear C4 respectively as the first key point and the second key point described above makes it possible to determine an orientation of the face. Utilizing the left shoulder C5 and the right shoulder C6 (or the left waist C11 and the right waist C12) as the first key point and the second key point makes it possible to determine an orientation of the torso.

Other configurations of the processing device 10 according to the present example embodiment are similar to those of the first to third example embodiments.

With the processing device 10 according to the present example embodiment, operations and effects similar to those of the first to third example embodiments are implemented. The processing device 10 according to the present example embodiment is able to identify an action of a human body based on time-series changes in orientation of the human body on an image. For example, the processing device 10 is able to identify a behavior of looking around, a behavior of looking in one direction, a behavior of looking around with only the face without moving the torso.

Application examples of the processing device 10 according to the present example embodiment will now be described herein. For example, it is possible to utilize the processing device 10 according to the present example embodiment in a predetermined facility such as store, a railway station, or an airport. A camera is installed in the facility. The camera captures an image of a person in the facility. The processing device 10 analyzes the image that the camera has captured and determines an action of the human body appearing in the image. In this case, the camera and the processing device 10 are configured to be communicable with each other. The processing device 10 may acquire the image that the camera has generated through real-time processing or batch processing.

In a case where a human body that performs a predetermined action is detected, the processing device 10 notifies a predetermined notification-target person of the detection. The “predetermined action” is, for example, but not limited to, a behavior of looking around or a behavior of looking around with only the face without moving the torso. The “notification-target person” is, for example, a staff, a supervisor, or a security guard of the facility. The processing device 10 uses a desired method such as an electronic mail or an application to provide a notification to the notification-target person.

### Modification

Here, a modification applicable to all the example embodiments will be described.

The reference value calculation unit 13 is able to take into consideration an attribute of a human body to calculate a reference value.

An “attribute of a human body” is one that is identifiable through image analysis, and is, for example, gender, age, or nationality. The reference value calculation unit 13 identifies such an attribute through image analysis.

As described in the second example embodiment, the reference value calculation unit 13 calculates, based on the height of a human body or the length of a predetermined part of the human body, which reference information indicates, a reference value indicating a distance between a first key point and a second key point on the human body in the lateral directions on an image in a case where the human body appears in the image in a predetermined orientation. The reference value calculation unit 13 calculates the reference value based on a calculation model for calculating a reference value from reference information.

In the modification, the calculation model is generated for each human body in each of a plurality of categories classified by the attribute. Each calculation model is optimized for each human body in each of the categories. The reference value calculation unit 13 calculates a reference value from reference information based on a calculation model corresponding to the identified attribute of the human body.

In the modification, the same operations and effects as those of the above example embodiments are also implemented. According to the modification, calculating a reference value corresponding to each human body makes it possible to more accurately determine an orientation of the human body on an image.

Although the example embodiments of the present invention have been described above with reference to the drawings, these are examples of the present invention, and various configurations other than the above can be used. The configurations of the above-described example embodiments may be combined with each other, or some of the configurations may be replaced with other configurations. The configurations of the above-described example embodiments may be modified in various forms within a range without departing from the gist. The configurations and processes disclosed in the above-described example embodiments and modifications may be combined with each other.

In the flowchart used in the above description, a plurality of steps (processes) are described in order. However, an execution order of the steps executed in each example embodiment is not limited to the described order. In each example embodiment, the order of the illustrated steps can be changed within a range in which there is no problem in terms of content. The above-described example embodiments can be combined within a range in which the contents are not contradictory.

Some or all of the above example embodiments may be described as the following supplementary notes, but are not limited to the following.

1. A processing device including:
a skeleton structure detection means for detecting a plurality of key points on a human body included in an image;
a reference information generation means for generating, based on the plurality of key points, reference information indicating a height of the human body or a length of a predetermined part of the human body;
a reference value calculation means for calculating, based on the reference information, a reference value indicating a distance between a first key point and a second key point on the human body in lateral directions on the image in a case where the human body has appeared in the image in a predetermined orientation;
an actual measurement value calculation means for calculating, based on the plurality of key points, an actual measurement value indicating a distance between the first key point and the second key point on the human body in the lateral directions on the image; and
an orientation determination means for determining, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

2. The processing device according to 1, in which the orientation determination means determines whether the human body is in a frontward orientation or a rearward orientation, whether the human body is in a rightward orientation or a leftward orientation, and a degree of lateral orientation of the human body, and determines, based on a result of the determination, the orientation of the human body on the image.

3. The processing device according to 2, in which the orientation determination means determines whether the human body is in the frontward orientation or the rearward orientation on the image based on a relative positional relationship between one of the key points on the right side part and one of the key points on the left side part of the human body, the one of the key points on the right side part and the one of the key points on the left side part forming a pair, in left and right directions on the image.

4. The processing device according to 2 or 3, in which the orientation determination means determines whether the human body is in the rightward orientation or the leftward orientation on the image based on at least one of:
whether one of the key points on the right side part of the human body and one of the key points on the left side part of the human body have been detected in the detection of the plurality of key points,
an orientation of an elbow indicated by one of the plurality of key points; and
an orientation of a knee indicated by one of the plurality of key points.

5. The processing device according to any one of 2 to 4, in which the orientation determination means determines a degree of the lateral orientation of the human body on the image based on a magnitude of the actual measurement value with respect to the reference value.

6. The processing device according to any one of 1 to 5, further including:
a detection means for detecting a detection target included in the image; and
a determination means for determining an action of the human body with respect to the detection target based on the orientation of the human body on the image and a position of the detection target on the image.

7. The processing device according to 6, in which
the detection means identifies an orientation of the detection target on the image, and
the determination means determines an action of the human body with respect to the detection target based on the orientation of the human body and the orientation of the detection target.

8. The processing device according to any one of 1 to 7, further including an identification means for identifying an action of the human body based on time-series changes in the orientation of the human body on the image.

9. A processing method including causing one or more computers to:
detect a plurality of key points on a human body included in an image;
generate, based on the plurality of key points, reference information indicating a height of the human body or a length of a predetermined part of the human body;
calculate, based on the reference information, a reference value indicating a distance between a first key point and a second key point on the human body in lateral directions on the image in a case where the human body has appeared in the image in a predetermined orientation;
calculate, based on the plurality of key points, an actual measurement value indicating a distance between the first key point and the second key point on the human body in the lateral directions on the image; and
determine, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

10. A program causing a computer to function as:
a skeleton structure detection means for detecting a plurality of key points on a human body included in an image;
a reference information generation means for generating, based on the plurality of key points, reference information indicating a height of the human body or a length of a predetermined part of the human body;
a reference value calculation means for calculating, based on the reference information, a reference value indicating a distance between a first key point and a second key point on the human body in lateral directions on the image in a case where the human body has appeared in the image in a predetermined orientation;
an actual measurement value calculation means for calculating, based on the plurality of key points, an actual measurement value indicating a distance between the first key point and the second key point on the human body in the lateral directions on the image; and
an orientation determination means for determining, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

This application is based upon and claims the benefit of priority from Japanese Patent Application No. 2023-064775, filed on Apr. 12, 2023, the disclosure of which is incorporated herein in its entirety by reference.

### REFERENCE SIGNS LIST

10 processing device
11 skeleton structure detection unit
12 reference information generation unit
13 reference value calculation unit
14 actual measurement value calculation unit
15 orientation determination unit
16 detection unit
17 determination unit
18 identification unit
1A processor
2A memory
3A input/output I/F
4A peripheral circuit

What is claimed is:

1. A processing apparatus comprising:
at least one memory configured to store one or more instructions; and
at least one processor configured to execute the one or more instructions to:
detect a plurality of key points on a human body included in an image;
generate, based on the plurality of key points, reference information indicating a height of the human body or a length of a predetermined part of the human body;
calculate, based on the reference information, a reference value indicating a distance between a first key point and a second key point on the human body in lateral directions on the image in a case where the human body has appeared in the image in a predetermined orientation;
calculate, based on the plurality of key points, an actual measurement value indicating a distance between the first key point and the second key point on the human body in the lateral directions on the image; and
determine, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

2. The processing apparatus according to claim 1, wherein the at least one processor is further configured to execute the one or more instructions to determine whether the human body is in a frontward orientation or a rearward orientation, whether the human body is in a rightward orientation or a leftward orientation, and a degree of lateral orientation of the human body, and determines, based on a result of the determination, the orientation of the human body on the image.

3. The processing apparatus according to claim 2, wherein the at least one processor is further configured to execute the one or more instructions to determine whether the human body is in the frontward orientation or the rearward orientation on the image based on a relative positional relationship between one of the key points on the right side part and one of the key points on the left side part of the human body, the one of the key points on the right side part and the one of the key points on the left side part forming a pair, in left and right directions on the image.

4. The processing apparatus according to claim 2, wherein the at least one processor is further configured to execute the one or more instructions to determine whether the human body is in the rightward orientation or the leftward orientation on the image based on at least one of:
whether one of the key points on the right side part of the human body and one of the key points on the left side part of the human body have been detected in the detection of the plurality of key points,
an orientation of an elbow indicated by one of the plurality of key points; and
an orientation of a knee indicated by one of the plurality of key points.

5. The processing apparatus according to claim 2, wherein the at least one processor is further configured to execute the one or more instructions to determine a degree of the lateral orientation of the human body on the image based on a magnitude of the actual measurement value with respect to the reference value.

6. The processing apparatus according to claim 1, wherein the at least one processor is further configured to execute the one or more instructions to:
detect a detection target included in the image; and
determine an action of the human body with respect to the detection target based on the orientation of the human body on the image and a position of the detection target on the image.

7. The processing apparatus according to claim 6, wherein the at least one processor is further configured to execute the one or more instructions to
identify an orientation of the detection target on the image, and
determine an action of the human body with respect to the detection target based on the orientation of the human body and the orientation of the detection target.

8. The processing apparatus according to claim 1, wherein the at least one processor is further configured to execute the one or more instructions to identify an action of the human body based on time-series changes in the orientation of the human body on the image.

9. A processing method comprising causing one or more computers to:
detect a plurality of key points on a human body included in an image;
generate, based on the plurality of key points, reference information indicating a height of the human body or a length of a predetermined part of the human body;
calculate, based on the reference information, a reference value indicating a distance between a first key point and a second key point on the human body in lateral directions on the image in a case where the human body has appeared in the image in a predetermined orientation;
calculate, based on the plurality of key points, an actual measurement value indicating a distance between the first key point and the second key point on the human body in the lateral directions on the image; and
determine, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

10. The processing method according to claim 9, further comprising causing the one or more computers to
determine whether the human body is in a frontward orientation or a rearward orientation, whether the human body is in a rightward orientation or a leftward orientation, and a degree of lateral orientation of the human body, and
determine, based on a result of the determination, the orientation of the human body on the image.

11. The processing method according to claim 10, further comprising causing the one or more computers to determine whether the human body is in the frontward orientation or the rearward orientation on the image based on a relative positional relationship between one of the key points on the right side part and one of the key points on the left side part of the human body, the one of the key points on the right side part and the one of the key points on the left side part forming a pair, in left and right directions on the image.

12. The processing method according to claim 10, further comprising the one or more computers to
determine whether the human body is in the rightward orientation or the leftward orientation on the image based on at least one of:
whether one of the key points on the right side part of the human body and one of the key points on the left side part of the human body have been detected in the detection of the plurality of key points,
an orientation of an elbow indicated by one of the plurality of key points; and
an orientation of a knee indicated by one of the plurality of key points.

13. The processing method according to claim 10, further comprising the one or more computers to determine a degree of the lateral orientation of the human body on the image based on a magnitude of the actual measurement value with respect to the reference value.

14. The processing method according to claim 9, further comprising causing the one or more computers to
detect a detection target included in the image; and
determine an action of the human body with respect to the detection target based on the orientation of the human body on the image and a position of the detection target on the image.

15. A non-transitory computer-readable medium storing a program causing a computer to:
detect a plurality of key points on a human body included in an image;
generate, based on the plurality of key points, reference information indicating a height of the human body or a length of a predetermined part of the human body;
calculate, based on the reference information, a reference value indicating a distance between a first key point and a second key point on the human body in lateral directions on the image in a case where the human body has appeared in the image in a predetermined orientation;
calculate, based on the plurality of key points, an actual measurement value indicating a distance between the first key point and the second key point on the human body in the lateral directions on the image; and
determine, based on the reference value, the actual measurement value, and a positional relationship, on the image, between one of the key points on a right side part of the human body and one of the key points on a left side part of the human body, whether the orientation of the human body on the image is one of a plurality of orientations represented by angles ranging from 0° to 360° inclusive.

16. The non-transitory computer-readable medium according to claim 15, wherein the program causes the computer to determine whether the human body is in a frontward orientation or a rearward orientation, whether the human body is in a rightward orientation or a leftward orientation, and a degree of lateral orientation of the human body, and determines, based on a result of the determination, the orientation of the human body on the image.

17. The non-transitory computer-readable medium according to claim 16, wherein the orientation the program causes the computer to determine whether the human body is in the frontward orientation or the rearward orientation on the image based on a relative positional relationship between one of the key points on the right side part and one of the key points on the left side part of the human body, the one of the key points on the right side part and the one of the key points on the left side part forming a pair, in left and right directions on the image.

18. The recording non-transitory computer-readable medium according to claim 16, wherein the program causes the computer to determine whether the human body is in the rightward orientation or the leftward orientation on the image based on at least one of:
whether one of the key points on the right side part of the human body and one of the key points on the left side part of the human body have been detected in the detection of the plurality of key points,
an orientation of an elbow indicated by one of the plurality of key points; and
an orientation of a knee indicated by one of the plurality of key points.

19. The non-transitory computer-readable medium according to claim 16, wherein the program causes the computer to determine a degree of the lateral orientation of the human body on the image based on a magnitude of the actual measurement value with respect to the reference value.

20. The non-transitory computer-readable medium according to claim 15, wherein the program further causes the computer to:
detect a detection target included in the image; and
determine an action of the human body with respect to the detection target based on the orientation of the human body on the image and a position of the detection target on the image.
